(19) United States
(12) Patent Application Publication
(10) Pub. No.: US 2017/0347237 A1
(43) Pub. Date: Nov. 30, 2017

(54) Determining Semantic Travel Modes

(71) Applicant: Google Inc., Mountain View, CA (US)

(72) Inventors: Alexander Varshavsky, Brooklyn, NY (US); Bhaskar Mehta, Menlo Park, CA (US); Chetan Bhadricha, Rego Park, NY (US); Stefano Maggiolo, London (GB)

(21) Appl. No.: 15/163,975

(22) Filed: May 25, 2016

(51) Int. Cl. H04W 4/02; H04W 40/24; H04L 12/24; H04W 88/02; H04W 84/12

(52) U.S. Cl. CPC H04W 4/027; H04W 40/244; H04L 41/22; H04L 41/026; H04W 4/028; H04W 84/12; H04W 88/02

(57) ABSTRACT

Systems and methods for determining semantic travel modes are provided. In one embodiment, a method can include obtaining a plurality of location reports from a user device. Each of the plurality of location reports can include at least a set of data indicative of an associated location and time. The method can further include determining a travel period associated with the user device based on the plurality of location reports. The method can include obtaining one or more personalization signals that include a set of data associated with a semantic travel mode. The method can include determining that the user device is associated with the semantic travel mode during the travel period based at least in part on the plurality of location reports and the one or more personalization signals.

### FIELD

The present disclosure relates generally to determining device location and activity, and more particularly to systems and methods for determining semantic travel modes associated with a user device.

### BACKGROUND

Many different techniques exist for attempting to determine a location associated with a device. For example, location based on GPS, IP address, cell triangulation, proximity to Wi-Fi access points, proximity to beacon devices, or other techniques can be used to identify a location of a device. Given the desire to respect user privacy, device location may only be determined if a user provides consent. Any authorized sharing of user location data can be secure and private, and can be shared only if additional consent is provided. For many purposes, user identity associated with the location of a device can be configured in an anonymous manner such that user assistance and information related to a specific location can be provided without a need for user-specific information.

The locations reported by one or more devices can be raw location data. For example, the reported location can be a geocode that identifies a latitude and longitude. Therefore, such raw location data can fail to identify a name of the particular entity (e.g. the name of the restaurant, park, or other point of interest) that the user was visiting at the time and/or how the user got there.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of ascertaining semantic travel modes. The method can include obtaining, by one or more computing devices, a plurality of location reports from a user device. Each of the plurality of location reports can include at least a set of data indicative of an associated location and time. The method can further include determining, by the one or more computing devices, a travel period associated with the user device based on the plurality of location reports. The method can include obtaining, by the one or more computing devices, one or more personalization signals that comprise a set of data associated with a semantic travel mode. The method can include determining, by the one or more computing devices, that the user device is associated with the semantic travel mode during the travel period based at least in part on the plurality of location reports and the one or more personalization signals.

Other example aspects of the present disclosure are directed to systems, apparatus, tangible, non-transitory computer-readable media, user interfaces, memory devices, and electronic devices for ascertaining semantic travel modes.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system according to example embodiments of the present disclosure;

FIG. 2 depicts an example graphical representation of a plurality of location reports according to example embodiments of the present disclosure;

FIG. 3 depicts an example user interface presented on a display device according to example embodiments of the present disclosure;

FIG. 4 depicts an example user interface presented on a display device according to example embodiments of the present disclosure;

FIG. 5 depicts an example user interface presented on a display device according to example embodiments of the present disclosure;

FIG. 6 depicts a flow chart of an example method for ascertaining semantic travel modes according to example embodiments of the present disclosure; and

FIG. 7 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to determining semantic travel modes associated with a user device. As used herein, a semantic travel mode refers to a mode of transportation associated with a user of a user device. For instance, a semantic travel mode can include walking, bike travel, auto-bike travel, automobile travel, bus travel, subway travel, rail travel, air travel, water travel, roller skate travel, etc. The systems and methods of the present disclosure can ascertain a semantic travel mode associated with a user device based, at least in part, upon location information associated with the user device, as well as personalization signals from the user device. For instance, the systems and methods can obtain a plurality of location reports from a user device. Each location report can include data indicative of an associated location and time. The personalization signals can include data associated with the user device that is indicative of one or more semantic travel modes. For instance, the personalization signals can include an email received and/or stored on the user device indicating that the user has purchased an airline ticket for a certain date and time. The systems and methods can analyze the plurality of location reports in conjunction with the personalization signals to determine that the user did indeed travel by the semantic travel mode (e.g., air travel) during a travel period.

More particularly, the system and methods of the present disclosure can include a user device (e.g., phone, wearable device) and a computing system (e.g., a cloud based server system). The user device can periodically provide raw location reports to the computing system implementing the present disclosure. Each location report can provide a time and a location associated with the user device. For example, the location included in each location report can be a geocode (e.g. latitude and longitude), IP address information, WiFi location information, or other information identifying or associated with a particular location.

A user can be provided with controls allowing the user to make an election as to both if and when systems, programs or features described herein may enable collection of user information (e.g., a user's current location, information about a user's social network, social actions or activities, profession, or a user's preferences), and if the user is sent content or communications from a server. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

The computing system can obtain the plurality of location reports from the user device. As described above, each of the plurality of location reports can include at least a set of data indicative of an associated location and time (e.g., associated with the user device). The computing system can analyzed the location reports to identify high quality reports. The computing system can determine a travel period associated with the user device based on the plurality of location reports. For instance, the computing system can determine whether or not the user device is traveling a certain distance within a certain time frame. In some implementations, the travel period can include one or more segment(s) in which the user device is traveling. The computing system can determine the one or more segment(s) of the travel period associated with the user device based, at least in part, on the plurality of location reports. A segment can be associated with a period of movement of the user device. By way of example, a travel period (e.g., where the user is traveling to a park) can include a first segment of the travel period (e.g., associated with travel to a first transit station) and a second segment (e.g., associated with travel from the first transit station to a second transit station near the park). The computing system can determine one or more segments of the travel period associated with the user device based, at least in part, on the plurality of location reports.

The computing system can obtain one or more personalization signals to help determine the semantic travel mode associated with the user device. For instance, the computing system can obtain one or more personalization signals (e.g., from the user device) that include a set of data associated with one or more semantic travel modes. By way of example, the personalization signals can be associated with an email indicative of the semantic travel mode, a web search query indicative of the semantic travel mode, a request indicative of the semantic travel mode, and a social media mention indicative of the semantic travel mode. In some implementations, personalization signals of higher significance can carry a greater analytical weight, as further described herein.

The computing system can determine, for each of the one or more segments of the travel period that the user device is associated with at least one of the semantic travel modes during the respective segment based, at least in part, on the plurality of location reports and the one or more personalization signals. For instance, the computing system can use the locations reports to determine that the user is moving during a segment of a travel period. The computing system can correlate the plurality of location reports with the personalization signals to determine if the user device is associated with one or more semantic travel modes.

By way of example, the personalization signals can indicate that a user purchased a subway ticket to travel from a first subway transit station to a second subway transit station (and/or a route of the subway). Additionally, and/or alternatively, the personalization signals can indicate a time period that is similar to the times associated with the travel period. The location reports can indicate that the start point of the segment is within the vicinity of the first subway station and/or that the end point of the segment is within the vicinity of the second subway station. Accordingly, the computing system can determine that the user device likely travelled via subway during that segment of the travel period. As further described herein, this determination can be further supported by intermediate location reports associated with a known route of the subway station (e.g., indicated in personalization signal).

In some implementations, the computing system can determine a speed associated with the user device based, at least in part, on at least some of the plurality of location reports. For instance, the computing system can utilize at least two of the location reports within one or more speed models to determine a speed at which the user device is travelling. Additionally, and/or alternatively, the computing system can use the location reports and the speed models to determine a velocity associated with the user device. Using the speed to supplement the location reports and/or the personalization signals, the computing system can determine the semantic travel mode associated with the user device based, at least in part, on the speed associated with the user device. For example, a slower speed may indicate that the user of the user device is walking, while a speed consistent with a typical speed of a subway train may indicate that the user is travelling via subway. In some implementations, the computing system can analyze the movement patterns (e.g., start/stop frequency) of the location reports to help determine the semantic travel mode, as further described herein.

Each semantic travel mode can be associated with at least one segment of the travel period. By way of example, the computing system can determine that the user of the user device travelled via a first semantic travel mode and a second semantic travel mode. The first semantic travel mode (e.g., walking) can be different than the second semantic travel mode (e.g., travelling via subway). As indicated above, the computing system can identify a first segment of the travel period (e.g., associated with travel to a first subway transit station) and a second segment of the travel period (e.g., associated with travel from the first subway transmit station to a second subway transit station). The computing system can determine that the user of the user device travelled via the first semantic travel mode (e.g., walking) during the first segment (e.g., to the transit station) and/or travelled via the second semantic travel mode (e.g., subway) during the second segment (e.g., between the transmit stations). Accordingly, the first segment can be associated with the first travel mode and the second segment can be associated with the second travel mode.

The computing system can send a set of data indicative of the one or more semantic travel modes associated with the user device to another computing system and/or the user device. For example, the computing system can send the set of data indicative of the semantic travel modes to an advertiser (e.g., to help determine advantageous ad placement) and/or to an entity that compiles, monitors, analyzes, etc. traffic data (e.g., to help city traffic patterns). Additionally, and/or alternatively, the computing system can provide for display, in a user interface presented on a display device associated with the user device, the first semantic travel mode (e.g., associated with the first segment) and the second semantic travel mode (e.g., associated with the second segment). The first and second semantic travel modes can be provided such that a user of the user device can confirm (e.g., via a user interface) at least one of that the user device is associated with the first semantic travel mode during the first segment and/or that the user device is associated with the second semantic travel mode during the second segment.

If the user confirms the semantic travel mode, the computing system can receive, from the user device, a confirmation indicating that a user of the user device was associated with the first semantic travel mode during the first segment of the travel period. Additionally, and/or alternatively, the confirmation can indicate that the user of the user device was associated with the second travel mode during the second segment of the travel period. The computing system can use such confirmations in later determinations of semantic travel modes.

Determining the semantic travel mode associated with a user device according to example aspects of the present disclosure represents acquisition of an additional useful data point regarding interest and use levels of different travel modes. Such knowledge can be useful for location-based services, advertisements, urban planning, etc. Moreover, the systems and methods of the present disclosure can help reduce the need and reliance for large, expensive, and error-prone geographic databases and further reduce the need for inefficient manual collection of data.

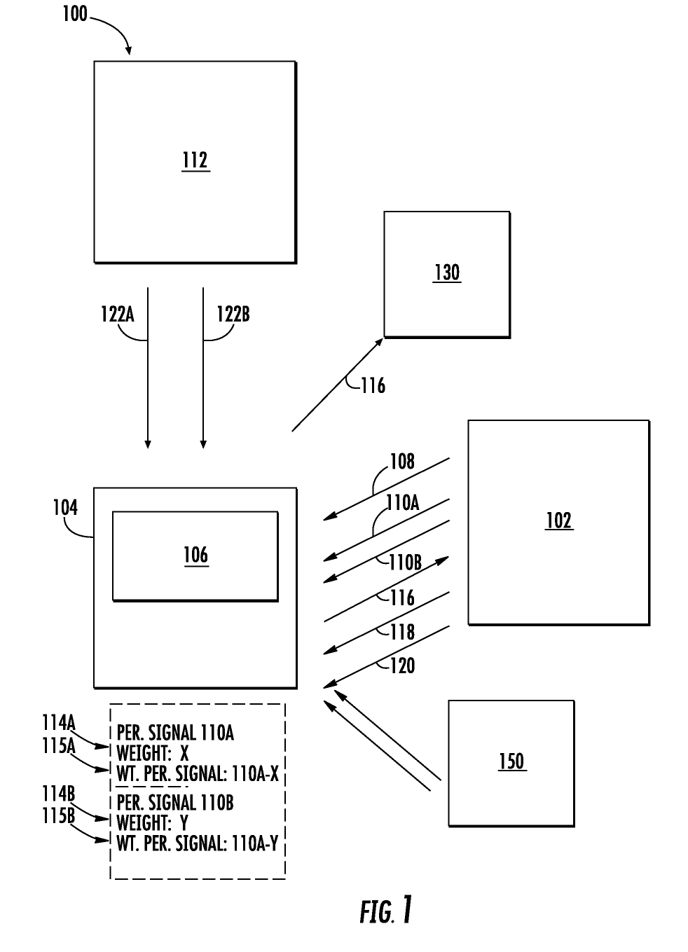

With reference now to the FIGS., example embodiments of the present disclosure will be discussed in further detail. FIG. 1 depicts an example system 100 for ascertaining semantic travel mode according to example embodiments of the present disclosure. As used herein, a semantic travel mode refers to a mode of transportation associated with a user of a user device. For instance, a semantic travel mode can include walking, bike travel, auto-bike travel, automobile travel, bus travel, subway travel, rail travel, air travel, water travel, human-powered travel (e.g., roller blade travel, skate travel, ski travel, snowshoe travel), etc. Each semantic travel mode can be designated by a semantic identifier (e.g. the common “name” of the travel mode, etc.), as distinguished from a coordinate-based or location-based identifier. However, in addition to a name, the data associated with a particular travel mode can further include one or more location associated with the travel modes, such as longitude, latitude, and altitude coordinates associated with the travel mode.

The system 100 can include a user device 102 and a computing system 104. In some implementations, the user device 102 and the computing system 104 can communicate with each other over a network. The user device 102 can be associated with a user. By way of example, the user device 102 can be a mobile device, personal communication device, a smartphone, navigation system, laptop computer, tablet, wearable computing device or the like.

The computing system 104 can be implemented using one or more computing device(s), such as, for example, one or more servers. The computing system 104 can include one or more computing device(s) 106 that include various components for performing various operations and functions. For example, and as further described herein, the computing device(s) 106 can include one or more processor(s) and one or more memory device(s). The one or more memory device(s) can store instructions that when executed by the one or more processor(s) cause the one or more processor(s) to perform the operations and functions, for example, as those described herein for ascertaining semantic travel modes. The computing device(s) 106 can be associated with, for instance, a server system (e.g., a cloud-based server system).

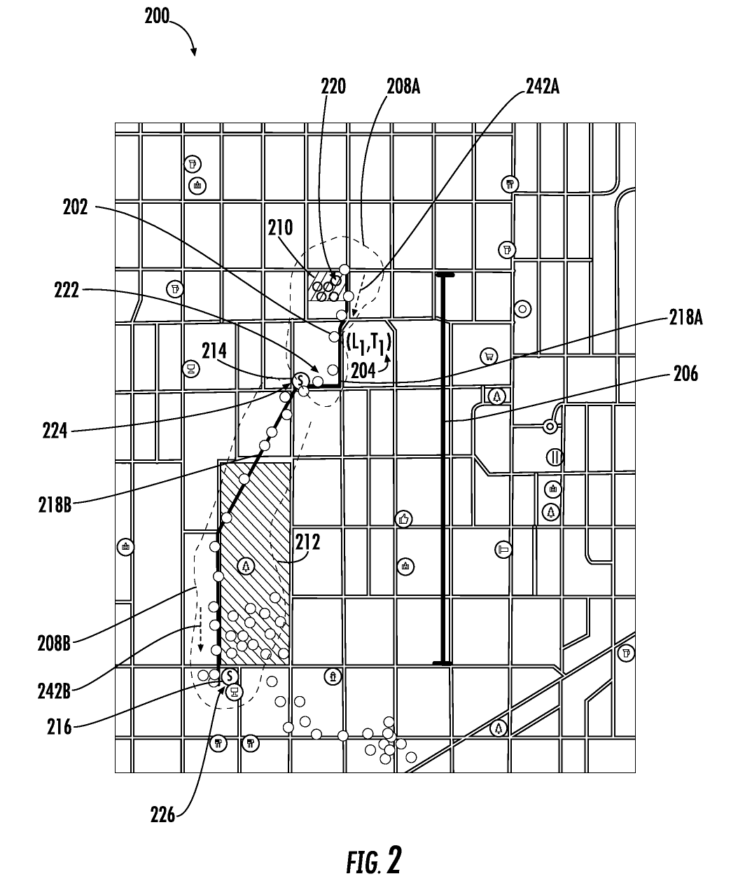

The user device 102 can be configured to periodically provide one or more raw location report(s) 108 to the computing device(s) 106. For example, FIG. 2 depicts an example graphical representation 200 of a plurality of location reports according to example embodiments of the present disclosure. In particular, the graphical representation 200 depicts a plurality of markers (e.g., marker 202) that respectively correspond to a plurality of locations respectively provided by a plurality of location reports 108. Thus, each marker 202 can correspond to a location at which a device associated with a user is thought to have been located at a particular time. Each of the plurality of location reports 108 can include at least a set of data 204 indicative of an associated location (e.g., L₁) and time (e.g., T₁). The user device 102 can provide the plurality of location reports 108 to the computing device(s) 106.

The computing device(s) 106 can be configured to obtain the plurality of location reports 108 from the user device 102. For instance, the computing system can periodically obtain location reports 108 via a network through which the computing device(s) 106 and the user device 102 can communicate. In some implementations, the computing device(s) 106 can analyzed the location reports 108 to identify high quality reports. A high quality report can be a report where the likelihood of being associated with a particular semantic travel mode is greater than a likelihood of being located at other semantic travel modes or none at all. A high quality report can occur, for instance, when the report is associated with one or more signal(s) indicative of the semantic travel mode, such as but not limited to, distance signals, past search history, past visits, Wi-Fi signal strengths, social signals (e.g. check-ins), and/or other signals.

The computing device(s) 106 can determine a travel period 206 associated with the user device 102 based on the plurality of location reports 108. The computing device(s) 106 can analyze the plurality of location reports 108 to determine whether and/or when the user device 102 is moving (versus not moving). For instance, the computing device(s) 106 can determine whether or not the user device 102 is traveling a certain distance within a certain time frame. In some implementations, the travel period 206 can include one or more segment(s) 208A-B in which the user device 102 is traveling. A segment 208A-B can be associated with a period of movement of the user device. In some implementations, a segment 208A-B can include one or more stops in the movement of the user device 102 (e.g., traffic lights, stop signs, subway stops, etc.), but can still be considered to be associated with a period of movement.

By way of example, a travel period 206 (e.g., where the user is traveling from building 210 to a park 212) can include a first segment 208A of the travel period 206 (e.g., associated with travel from the building 210 to a first subway transit station 214) and a second segment 208B (e.g., associated with travel from the first subway transit station 214 to a second subway transit station 216). The computing device(s) 106 can determine a segment 208A-B of the travel period 206 associated with the user device 102 based, at least in part, on the plurality of location reports 108. In some implementations, a large time lapse can exist between segments of the travel period 206.

Returning to FIG. 1, the computing device(s) 106 can be configured to obtain one or more personalization signals 110A-B that comprise a set of data associated with a semantic travel mode. A personalization signal(s) 110A-B can include data that is specific to the user and/or includes data indicative of a user's interest and/or association with a travel mode. The personalization signal(s) 110A-B can be associated with, for example, an email indicative of the semantic travel mode, a web search query indicative of the semantic travel mode, a request indicative of the semantic travel mode, a social media mention indicative of the semantic travel mode, etc. By way of example, the personalization signal(s) 110A-B can include an email indicating that the user of the user device 102 has purchased a ticket for the subway to travel from the first subway transit station 214 to the second subway transit station 216 and/or a time similar to that of the second segment 208B. In some implementations, the personalization signal(s) 110A-B can indicate a route associated with a semantic travel mode and/or other information related to the semantic travel mode.

Additionally, and/or alternatively, the personalization signal(s) 110A-B can include one or more signal(s) from one or more sensor(s) associated with the user device 102. For example, the user device 102 can include a sound recording device, atmospheric sensor, vibration sensor, biometric sensor, etc. By way of example, the sound recording device and/or atmospheric sensor can record wind noise and/or wind speed associated with the user device 102 during travel. The wind noise and/or wind speed can be higher, for example, when riding on a bike than when riding in an enclosed subway train. The personalization signal(s) 110A-B can include a set of data acquired by the one or more sensor(s) associated with the user device 102. The personalization signal(s) 110A-B can, thus, support and/or oppose the determined semantic travel mode for a segment 208A-B.

The computing device(s) 106 can be configured to determine that the user device 102 is associated with a semantic travel mode during a segment 208A-B of the travel period 206 based, at least in part, on the plurality of location reports 108 and the one or more personalization signal(s) 110A-B. For instance, the computing device(s) 106 can use the locations reports 108 to determine that the user device 102 is moving during a segment 208A-B of a travel period 206. In some implementations, the computing device(s) can consider other information, as further described herein. The computing device(s) 106 can correlate the plurality of location reports 108 with the personalization signal(s) 110A-B to determine if the user device 102 is associated with one or more semantic travel mode(s) (e.g., walking, subway).

By way of example, the computing device(s) 106 can determine a first semantic travel mode for the first segment 208A. One or more personalization signal(s) 110A-B can be associated with the building 210 and the first subway station 214, for the first segment 208A of the travel period 206. For example, the personalization signal(s) 110A-B can include a text message indicating that the user of the user device 102 intends to and/or is walking from the building 210 to the first subway transit station 214. The location reports 108 can indicate that the start pointing 220 of the first segment 208A is within the vicinity of the building 210 and/or that the end point 222 of the first segment 208A is within the vicinity of the first subway station 214. Additionally and/or alternatively, one or more of the location report(s) 108 can appear to correlate with the one or more intermediate point(s) 218A (e.g., route of the walking path), such that it appears that the user device 102 is general traveling in a path that is consistent with the walking path between the building 210 and the first subway transit station 214. Thus, the computing device(s) 106 can determine that the user of the user device 102 likely walked during the first segment 208A of the travel period 206. In this way, the computing device(s) 106 can determine a first semantic travel mode (e.g., walking) associated with the user device 102 during the first segment 208A of the travel period 206.

Additionally, and/or alternatively, the computing device(s) 106 can determine a second semantic travel mode for the second segment 208B. For example, the personalization signal(s) 110A-B can be associated with the first subway station 214 and/or the second subway station 216 for the second segment 208B of the travel period 206. For example, the personalization signal(s) 110A-B can include an email indicating that the user of the user device 102 purchased a subway ticket to travel between the first and second subway transit stations 214, 216. The location reports can indicate that the user of the user device 102 may be associated with the second semantic travel mode (e.g., travelling via subway). For example, the location reports 108 can indicate that a start pointing 224 of the second segment 208B is within the vicinity of first subway station 214 and/or that the end point 226 of the second segment 208B is within the vicinity of the second subway station 216. The computing device(s) 106 can determine that the user of the user device 102 likely travelled via subway during the second segment 208B of the travel period 206. In this way, the computing device(s) 106 can determine a second semantic travel mode (e.g., travelling via subway) associated with the user device 102 during the second segment 208B of the travel period 206.

In some implementations, the determination of the semantic travel mode can be bolstered by a correlation of existing locations reports to the personalization signal(s) 110A-B and/or a lack of existing locations reports. For example, the one or more personalization signal(s) 110A-B can be associated with the route of a subway line between the first subway station 214 and the second subway station 216 (e.g., a route indicated in the email message). The computing device(s) 106 can determine that one or more of the location report(s) 106 correlate with the one or more intermediate point(s) 218B (e.g., route of the subway line), such that it appears the user device 102 is general traveling in a path that is consistent with the subway line. The computing device(s) 106 can use this to further its determination that the user of the user device 102 likely travelled via subway during the second segment 208B of the travel period 206.

In some implementations, the computing device(s) 106 may not obtain one or more location reports between the first subway station 214 and the second subway station 216. This can be due to the lack of communicability of the user device 102 while travelling via subway. In such a case when a lack of location reports 108 (e.g., between the start and end points) is expected for a particular type of semantic travel mode (e.g., subway, aircraft), a period showing a lack of location reports 108 that correlate to the personalization signal(s) 110A-B (e.g., indicative of a route of the semantic travel mode) can further a determination that the user of the user device 102 is associated with that semantic travel mode during that segment of the travel period 206.

In some implementations, the computing device(s) 106 can be configured to weigh the personalization signal(s) of higher significance to carry a greater analytical weight. For instance, as shown in FIG. 1, the one or more personalization signal(s) 110A-B can include the first personalization signal 110A and the second personalization signal 110B. The first personalization signal 110A can include a text message indicating that the user has and/or is traveling according to a semantic travel mode (e.g., walking). The second personalization signal 110B can include a social media mention indicating that the user approves of and/or “likes” a certain semantic travel mode (e.g., a social media approval of bike travel). The computing device(s) 106 can determine a first weight 114A for the first personalization signal 110A and a second weight 114B for the second personalization signal 110B. The first weight 114A can be greater than the second weight 114B. For instance, the first personalization signal 110A (e.g., associated with the text message) can be given a greater weight than the second personalization signal 110B (e.g., associated with the social media mention), such that a correlation between one or more location report(s) 108 with the first personalization signal 110A is afforded greater weight than a correlation of one or more location report(s) 108 with the second personalization signal 110B. The computing device(s) 106 can assign the first weight 114A to the first personalization signal 110A to create a first weighted geographic signal 115A and the second weight 114B to the second personalization signals 110B to create a second weighted personalization signal 115B. The computing device(s) 106 can determine the semantic travel mode associated with the user device 102 based, at least in part, on the weighted first personalization signal 115A and/or the weighted second personalization signal 115B. In this way, the computing device(s) 106 can create (and utilize) a hierarchical model for determining a semantic travel mode associated with a user device 102.

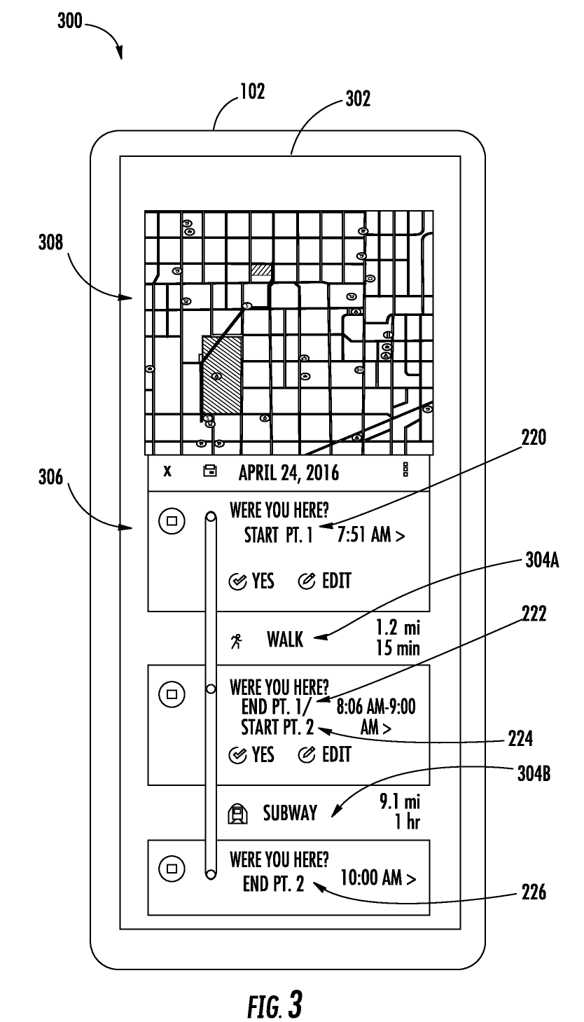

The computing device(s) 106 can be configured to provide a set of data 116 (e.g., shown in FIG. 1) indicative of the semantic travel mode associated with the user device 102. For instance, FIG. 3 depicts an example user interface 300 presented on a display device 302 according to example embodiments of the present disclosure. The computing device(s) 106 can be configured to provide for display the semantic travel mode 304A-B in a user interface 300 presented on a display device 302 associated with the user device 102. As shown, the user interface 300 can include a timeline 306 and a map 308. The map 308 can indicate a route travelled by the user device 102. The timeline 306 can provide a listing (e.g., chronological) of one or more semantic travel mode(s) 304A-B and/or the start and end points 220, 222, 224, 226 of the one or more segment(s) 208A-B of the travel period 206. For example, the timeline 306 can indicate that on Apr. 24, 2016, the user of the user device 102 travelled from the start point 220 (e.g., building 210) to the end point 222 (e.g., first subway transit station 222) via a first semantic travel mode 304A (e.g., walking). The user interface 300 can be indicative of the time (e.g., “7:51 AM”) at which the user device 102 left the start point 220, the time at which the user device 102 arrived at the end point 222 (e.g., “8:06 AM”), the travelling time associated with the first semantic travel mode 304B (e.g., “15 min”), the distance associated with the first semantic travel mode 403B (e.g., “1.2 mi”), and/or any other information associated with the first segment 208A. As shown, similar such information can be provided for a second semantic travel 304B (e.g., travelling via subway) and/or the second segment 208B of the travel period 206. In some implementations, the start and end points 220, 222, 224, 226 can be identified based on semantic place names (e.g., locations visited by the user).

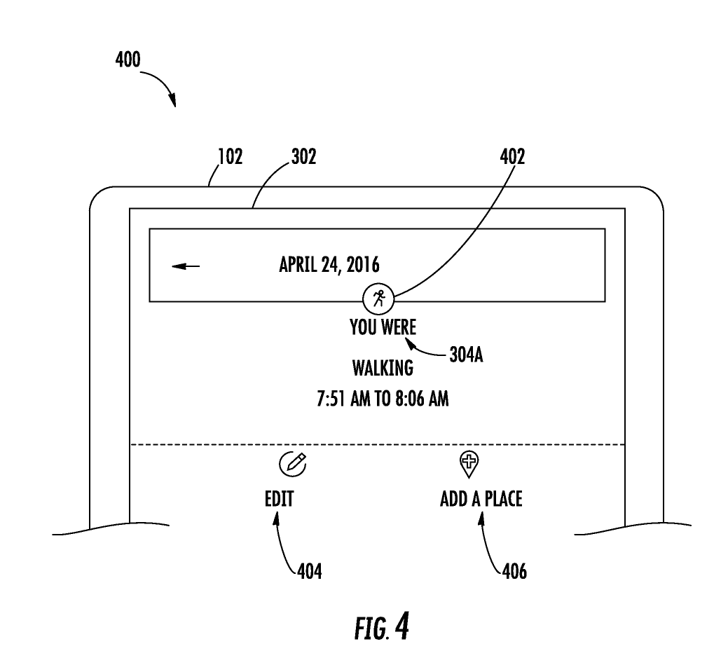

Additionally, and/or alternatively, the semantic travel mode 304A-B can be provided (e.g., to the user device 102) such that a user of the user device 102 can confirm the semantic travel mode 304A-B. For example, FIG. 4 depicts an example user interface 400 presented on the display device 302 according to example embodiments of the present disclosure. The user interface 400 can be presented on the display device 302 of user device 102 such that a user can confirm that the user of the user device 102 is (and/or was) associated with the semantic travel 304A-B during the travel period 206. For example, a user of the user device 102 can interact with (e.g., a touch interaction, audio interaction) the user interface 400 via a first interactive element 402 (e.g., soft button) to confirm the first semantic travel mode 304A (e.g. walking) during the travel period 206 (e.g., the first segment 208A). The computing device(s) 106 can receive a confirmation 118 (e.g., shown in FIG. 1) that the user device 102 is associated with the semantic travel mode 304A-B during the travel period 206. The confirmation can include a set of data indicative of the user's verification of the semantic travel mode 304A-B. The computing device(s) 106 can determine that the user device 102 is associated with the semantic travel mode 304A-B during the travel period 206 based, at least in part, on the confirmation 118.

The user interface 400 can also, and/or alternatively, enable a user to edit the semantic travel mode 304A-B and/or information associated with the travel period 206. For instance, the user of the user device 102 can interact with the user interface 400 via a second interactive element 404 to edit the first semantic travel mode 304A (e.g. walking) during the travel period 206. For example, the user can edit the first semantic travel mode 304A to indicate that the user travelled via bike during the first segment 208A of the travel period 206. In some implementations, the user can edit (e.g., via a third interactive element 406) information associated with the travel period 206, such as, to edit the start and/or end points associated with a segment 208A-B. The computing device(s) 106 can be configured to obtain, from the user device 102, an edit 120 (as shown in FIG. 1) indicating that the user device 102 is associated with a different semantic travel mode during the travel period 206. The edit 120 can include a set of data indicative of the user's edit of the semantic travel mode 304A-B and/or information associated with the travel period 206. The computing device(s) 106 can determine that the user device 102 is associated with the different semantic travel mode during the travel period 206 based, at least in part on, the edit 120.

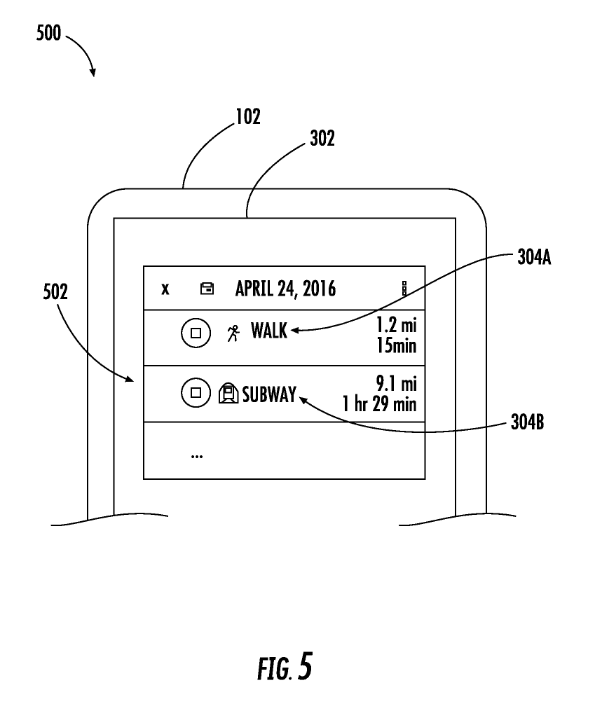

In some implementations, the computing device(s) 106 can be configured to store the semantic travel mode 304A-B as part of a travel mode history for the user device 102. In some implementations, the computing device(s) 106 can provide for display the travel mode history in a user interface presented on a display device associated with the user device 102. For example, FIG. 5 depicts an example user interface 500 presented on the display device 302 of the user device 102 according to example embodiments of the present disclosure. As shown, a travel mode history 502 can indicate the travel mode(s) 304A-B associated with user device 102. Additionally, and/or alternatively, the user interface 500 can include information associated with the travel mode(s) 304A-B (e.g., distance travelled, time travelled). As further described herein, in some implementations, the computing device(s) 106 can be configured to determine that the user device 102 is associated with the semantic travel mode 304A-B during the travel period 206 based, at least in part, on the travel mode history.

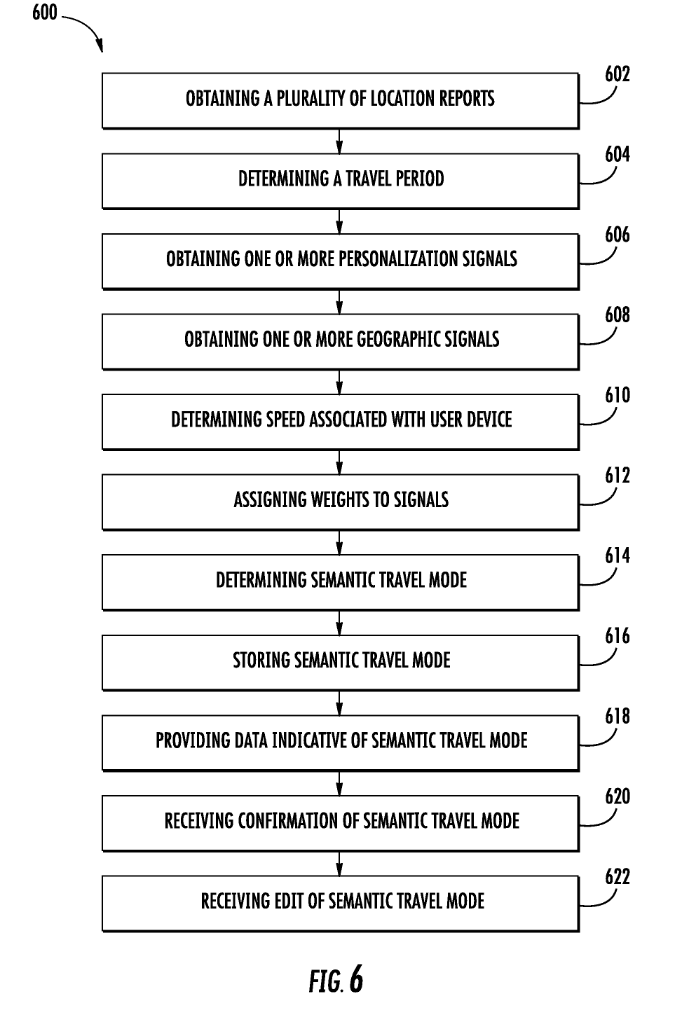

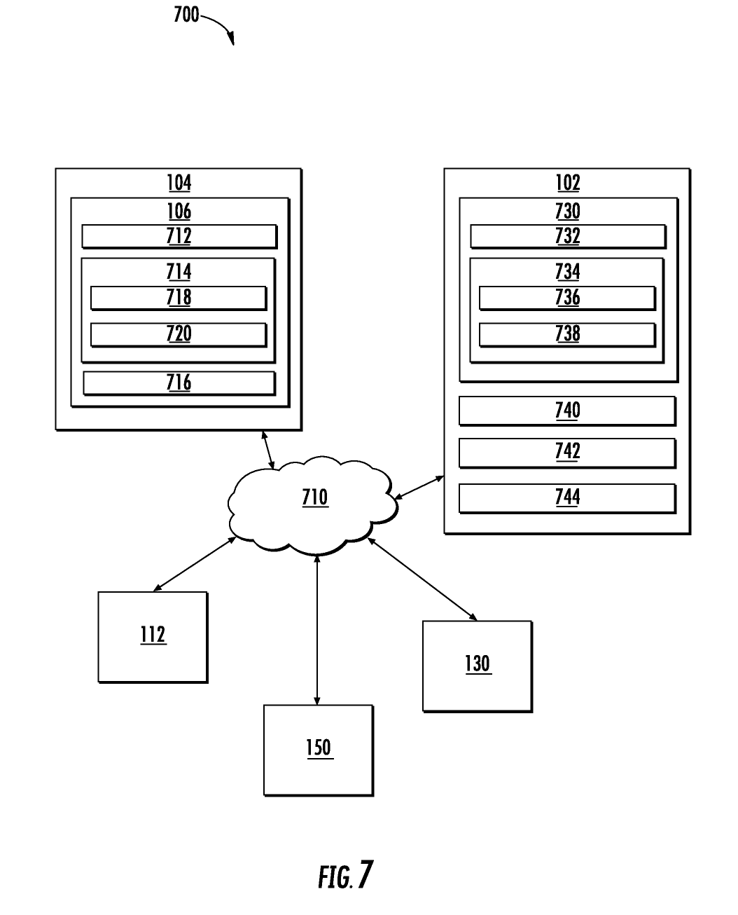

FIG. 6 depicts a flow chart of an example method 600 for ascertaining semantic travel modes according to example embodiments of the present disclosure. Method 600 can be implemented by one or more computing device(s), such as one or more of the computing device(s) depicted in FIGS. 1 and 7. FIG. 6 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (602), the method 600 can include obtaining a plurality of location reports. For instance, the computing device(s) 106 can obtain a plurality of location reports 108 from a user device 102. Each of the plurality of location reports 108 can include at least a set of data 204 indicative of an associated location (L₁) and/or time (T₁). At (604), the method 600 can include determining a travel period. For instance, the computing device(s) 106 can determine a travel period 206 (and/or a segment 208A-B of a travel period 206) associated with the user device 102 based, at least in part, the plurality of location reports 108. The segment 208A-B can be associated with a period of movement of the user device 102. As further described herein, in some implementations, a semantic travel mode 304A-B can be associated with the segment 208A-B of the travel period 206.

At (606), the method can include obtaining one or more personalization signals. For instance, the computing device(s) 106 can obtain, from the user device 102, one or more personalization signal(s) 110A-B that include a set of data associated with a semantic travel mode 304A-B. The personalization signal(s) 110A-B can be associated with at least one or an email indicative of the semantic travel mode 304A-B, a web search query indicative of the semantic travel mode 304A-B, a request indicative of the semantic travel mode 304A-B, and/or a social media mention indicative of the semantic travel mode 304A-B, etc. Additionally, and/or alternatively, the personalization signal(s) 110A-B can include one or more signal(s) from one or more sensor(s) associated with the user device 102. For example, the user device 102 can include a sound recording device, atmospheric sensor, vibration sensor, biometric sensor, etc. The personalization signal(s) 110A-B can, for example, include a set of data associated with at least one of a sound recording device, a biometric sensor, and/or a vibration sensor.

At (608), the method can include obtaining one or more geographic signals. For instance, as shown in FIG. 1, the computing device(s) 106 can obtain one or more geographic signal(s) 122A-B to help determine a semantic travel mode associated with the user device 102. For instance, the computing device(s) 106 can be configured to obtain one or more geographic signal(s) 122A-B including a set of data associated with one or more geographic location(s). The geographic location(s) can be indicative of the locations of one or more element(s) associated with a semantic travel mode 304A-B (e.g., subway transit stations, railroad tracks, bike share stations, bike paths, airports, trails). For instance, a geographic signal 122A-B can include a set of data that is indicative of the location of the building 210, the park 212, the first and/or second subway transit stations 214, 216, a route associated with a walking path, a route associated with a subway line, etc. In some implementations, the computing device(s) 106 can obtain the geographic signal(s) 122A-B from a remote computing system 112 that, for example, compiles, stores, maintains, analyzes, etc. various types of data and information such as geographic data, map data, publically available data, satellite acquired data, etc. In some implementations, the geographic signal(s) 122A-B can be obtained from the user device 102.

In some implementations, the one or more geographic signal(s) can include one or more first geographic signal(s) 122A and one or more second geographic signal(s) 122B. The first geographic signal(s) 122A can be associated with a starting point or an ending point associated with a segment of the travel period. For example, with reference to FIG. 2, the first geographic signal(s) 122A can be associated with a starting point 220 (e.g., in the vicinity of the building 210) and/or an ending point 222 (e.g., in the vicinity of the first subway transit station 214) associated with the first segment 208A of the travel period 206. Additionally, and/or alternatively, the first geographic signal(s) 122A can be associated with the starting point 224 (e.g., in the vicinity of the first subway transit station 214) and/or the ending point 226 (e.g., in the vicinity of the second subway transit station 216) associated with the second segment 208B of the travel period 206.

Additionally, and/or alternatively, the one or more second geographic signal(s) 122B can be associated with one or more intermediate point(s) 218A-B associated with a segment 208A-B of the travel period 206. The intermediate point(s) 218A-B can be associated with a path, route, trajectory, etc. of a semantic travel mode. The second geographic signal(s) 122B can include a set of data associated with the geographic locations of such a path, route, trajectory, etc. and/or other information of the semantic travel mode. For example, the intermediate point(s) 218A-B can be associated with a walking path, a bike path, a subway line route, train tracks, an aircraft trajectory, etc. As shown in FIG. 2, the one or more second geographic signal(s) 122B can be associated with one or more first intermediate point(s) 218A of the first segment 208A (e.g., points along a walking path) and/or one or more second intermediate point(s) 218B of the second segment 208B (e.g., points along a subway line route). The computing device(s) 106 can determine the semantic travel mode 304A-B associated with the user device 102 based, at least in part, on the one or more geographic signal(s) 122A-B. In some implementations, geographic signals 122 of higher significance can carry a greater analytical weight during such a determination.

Returning to FIG. 6, in some implementations, the method 600 can include determining a speed associated with the user device (e.g., at (610)). For instance, the computing device(s) 106 can determine a speed 242A-B (e.g., shown in FIG. 2) associated with the user device 102 based, at least in part, on at least some of the plurality of location reports 108. For instance, the computing device(s) 106 can utilize at least two of the location reports 108 (and/or high quality reports) within one or more speed model(s) to determine a speed 242A-B at which the user device 102 is travelling. Additionally, and/or alternatively, the computing device(s) 106 can use the location reports 108 and the speed models to determine a velocity associated with the user device 102. The computing device(s) 106 can determine that the user device 102 is associated with the semantic travel mode 304A-B during the travel period 206 based, at least in part, on the speed 242A-B associated with the user device 102. For example, a first speed 242A (e.g., a slower speed) may indicate that the user of the user device 102 is associated with a first semantic travel mode 304A (e.g., walking), while a second speed 242B (e.g., consistent with a typical speed of a subway train) may indicate that the user of the user device 102 is associated with a second semantic travel mode 304B (e.g., travelling via subway).

Additionally and/or alternatively, the computing device(s) 106 can analyze the movement patterns of the location reports 108 to help determine the semantic travel mode 304A-B. For example, the computing device(s) 106 can analyze the location reports 108 to determine the start and/or stop frequency of the user device 102 during a segment 208A-B of the travel period 206. For example, if the movement pattern of the user device 102 is consistent with the movement of a subway train on its route between the first and second transit stations 214, 216, then the movement pattern can further support the determination that the user of the user device 102 is travelling via subway during the second segment 208B. However, if the movement pattern of the user device 102 is inconsistent with the movement of a subway train on its route between the first and second transit stations 214, 216, then the movement pattern can weigh against a determination that the user of the user device 102 is travelling via subway during the second segment 208B. This may cause the computing device(s) 106 to perform additional analysis on the location reports 108, the personalization signals 110A-B, and/or the geographic signals 122A-B.

At (612), the method 600 can include assigning one or more weight(s) to the personalization signals (and/or the geographic signals). For example, the computing device(s) 106 can process the one or more personalization signal(s) 110A-B such that a first personalization signal 110A is afforded a greater weight when determining the semantic travel mode 304A-B associated with the user device 102 than a second personalization signal 110B. As described herein, this can create a hierarchical model for the determination of a semantic travel mode.

At (614), the method 600 can include determining a semantic travel mode. For instance, the computing device(s) 106 determine that the user device 102 is associated with the semantic travel mode 304A-B during the travel period 206 based, at least in part, on the plurality of location reports 108 and the one or more personalization signal(s) 110A-B, as described herein. In some implementations, the computing device(s) 106 can determine a semantic travel mode 304A-B associated with the user device 102 based, at least in part, the speed 242A-B associated with the user device 102, the geographical signal(s) 122A-B, and/or other data (e.g., confirmations 118, edits 120), as described herein.

In some implementations, a plurality of candidate semantic travel modes can be identified for a segment of the travel period 206. The computing device(s) 106 can be configured to determine which of the candidate semantic travel modes is associated with the segment of the travel period 206. For instance, the computing device(s) 106 can determine a confidence score for each of the plurality of candidate semantic travel modes based, at least in part, the personalization signal(s) 110A-B and the location reports 108. The confidence score can be indicative of the likelihood (e.g. probability) of a location report being associated with a particular candidate semantic travel mode. The confidence score can be determined based on various factors. One factor can be the distance between a location associated with the location report and one or more points associated with the semantic travel mode (e.g., as indicated by the personalization signals 110A-B). Other suitable factors can be based on signals indicative of the geographic signal(s) 122A-B, the speed 242A-B, a movement pattern of the user device 102, location history, travel mode history 502, and other information.

At (616), the method 600 can include storing the semantic travel mode. For instance, the computing device(s) 106 can store the semantic travel mode 304A-B as part of a travel mode history 502 for the user device 102. The travel mode history 502 can be provided for display in a user interface 500 presented on a display device 302 associated with the user device 102. Additionally, and/or alternatively, the computing device(s) 106 can determine that the user device 102 is associated with the semantic travel mode 304A-B during the travel period based, at least in part, on a travel mode history 502.

For example, the travel mode history 502 can be an individual travel mode history that is associated with the user device 102 and/or the user of the user device 102. The travel mode history 502 can include one or more past semantic travel mode(s) associated with a user of the user device 102. Additionally, and/or alternatively, the individual travel mode history can include one or more confirmation(s) 118 and/or edit(s) 120 obtained by the computing device(s) 106. In this way, the computing device(s) 106 can use machine learning techniques to build an individual model associated with the semantic travel history of the user device 102 and refine the model overtime. The computing device(s) 106 can use this individual model to help determine the semantic travel modes 304A-B associated with a user device during a travel period 206.

In some implementations, the travel mode history 502 can include one or more semantic travel mode(s) associated with one or more other user device(s) that are different than the user device 102. For example, as shown in FIG. 1, the computing device(s) 106 can determine one or more semantic travel mode(s) for one or more other user device(s) 150. This can be based on location reports, personalization signals, geographic signals, other related information, etc. associated with the other user device(s) 150. In this way, the computing device(s) 106 can use machine learning techniques to build a generic model associated with the semantic travel history of a plurality of user devices and refine the model overtime. The computing device(s) 106 can use this generic model to help determine the semantic travel modes 304A-B associated with a user device 102 during a travel period 206. For example, the computing device(s) 106 can use this generic model for the user device 102 in the event that no individual model exists for a user and/or the user device 102. In some implementations, the computing device(s) 106 can use this generic model for the user device 102 in the event that a user of the user device 102 does not confirm and/or edit the semantic travel mode(s) 304A-B.

Additionally, and/or alternatively, at (618) the method 600 can include providing data indicative of a semantic travel mode. For instance, the computing device(s) 106 can provide a set of data 116 indicative of the semantic travel mode 304A-B associated with the user device 102. As described herein, the computing device(s) 106 can provide for display the semantic travel mode 304A-B in a user interface 300 presented on a display device 302 (e.g., associated with the user device 102). Additionally, and/or alternatively, the computing device(s) 106 can provide the set of data 116 indicative of the semantic travel mode 304A-B associated with the user device 102 to one or more third party entities 130 (e.g., shown in FIG. 1). For example, the computing device(s) 106 can provide the set of data 116 to an advertiser (e.g., to help determine advantageous ad placement) and/or to an entity that compiles, monitors, analyzes, etc. traffic data (e.g., to help city traffic patterns).

At (620) and/or (622), the method 600 can include obtaining a confirmation of the semantic travel mode and/or an edit of the semantic travel mode. For instance, the computing device(s) 106 can obtain, from the user device 102, a confirmation 118 that the user device 102 is associated with the semantic travel mode 304A-B during the travel period 206. The computing device(s) 106 can determine that the user device 102 is associated with the semantic travel mode 304A-B during the travel period 206 based, at least in part, on the confirmation 118. Additionally, and/or alternatively, the computing device(s) 106 can receive, from the user device 102, an edit 120 indicating that the user device 102 is associated with a different semantic travel mode during the travel period 206. The computing device(s) 106 can determine that the user device 102 is associated with the different semantic travel mode during the travel period 206 based, at least in part, on the edit 120. The confirmation 118 and/or the edit 120 can be used by the computing device(s) 106 to build the individual model (and/or the generic model) for determining semantic travel modes, as described above.

FIG. 7 depicts an example computing system 700 that can be used to implement the methods and systems according to example aspects of the present disclosure. The system 700 can be implemented using a client-server architecture that includes the computing system 104 (e.g., including one or more server(s)) that communicates with one or more user device(s) 102 over a network 710. The system 700 can be implemented using other suitable architectures, such as a single computing device.

The system 700 includes the computing system 104 that can include, for instance, a web server and/or a cloud-based server system. The computing system 104 can be implemented using any suitable computing device(s) 106. The computing device(s) 106 can have one or more processors 712 and one or more memory devices 714. The computing device(s) 106 can also include a network interface 716 used to communicate with one or more other component(s) of the system 700 (e.g., user device 102, remote computing device 112, third party entity 130, other user device 150) over the network 710. The network interface 716 can include any suitable components for interfacing with one more networks, including for example, transmitters, receivers, ports, controllers, antennas, or other suitable components.

The one or more processors 712 can include any suitable processing device, such as a microprocessor, microcontroller, integrated circuit, logic device, or other suitable processing device. The one or more memory devices 714 can include one or more computer-readable media, including, but not limited to, non-transitory computer-readable media, RAM, ROM, hard drives, flash drives, or other memory devices. The one or more memory devices 714 can store information accessible by the one or more processors 712, including computer-readable instructions 718 that can be executed by the one or more processors 712. The instructions 718 can be any set of instructions that when executed by the one or more processors 712, cause the one or more processors 712 to perform operations. In some embodiments, the instructions 718 can be executed by the one or more processor(s) 712 to cause the one or more processor(s) 712 to perform operations, such as any of the operations and functions for which the computing system 104 and/or the computing device(s) 106 are configured, the operations for ascertaining semantic travel modes (e.g., method 600), as described herein, and/or any other operations or functions of the computing system 104 and/or the computing device(s) 106. The instructions 718 can be software written in any suitable programming language or can be implemented in hardware. Additionally, and/or alternatively, the instructions 718 can be executed in logically and/or virtually separate threads on processor(s) 712.

As shown in FIG. 7, the one or more memory devices 714 can also store data 720 that can be retrieved, manipulated, created, or stored by the one or more processors 712. The data 720 can include, for instance, data associated with location reports, personalization signals, geographic signals, travel mode histories, location histories, semantic travel modes, travel periods (and/or segments thereof), confirmations, edits, and/or other data or information. The data 720 can be stored in one or more databases. The one or more databases can be connected to the computing device(s) 106 by a high bandwidth LAN or WAN, or can also be connected to computing device(s) 106 through network 710. The one or more databases can be split up so that they are located in multiple locales.

The computing device(s) 106 can exchange data with one or more user device(s) 102 over the network 710. Although one user device 102 is illustrated in FIG. 7 (and herein), any number of user devices 102 can be connected to computing device(s) 106 over the network 710. Each of the user devices 102 can be any suitable type of computing device, such as a general purpose computer, special purpose computer, laptop, desktop, mobile device, navigation system, smartphone, tablet, wearable computing device, a display with one or more processors, or other suitable computing device. The other user device(s) 150 can have a similar component structure as shown for the user device 102.

A user device 102 can include one or more computing device(s) 730. The one or more computing device(s) 730 can include one or more processor(s) 732 and a memory 734. The one or more processor(s) 732 can include one or more central processing units (CPUs), graphics processing units (GPUs) dedicated to efficiently rendering images or performing other specialized calculations, and/or other processing devices. The memory 734 can include one or more computer-readable media and can store information accessible by the one or more processors 732, including instructions 736 that can be executed by the one or more processors 732 and data 738. For instance, the memory 734 can store instructions 736 for implementing a user interface module for displaying semantic travel modes determined according to example aspects of the present disclosure. In some embodiments, the instructions 736 can be executed by the one or more processor(s) 732 to cause the one or more processor(s) 732 to perform operations, such as any of the operations and functions for which the user device 102 is configured, as described herein, and/or any other operations or functions of the user device 102. The instructions 736 can be software written in any suitable programming language or can be implemented in hardware. Additionally, and/or alternatively, the instructions 736 can be executed in logically and/or virtually separate threads on processor(s) 730.

The user device 102 of FIG. 7 can include various input/output devices 740 for providing and receiving information from a user, such as a touch screen, touch pad, data entry keys, speakers, and/or a microphone suitable for voice recognition. For instance, the user device 102 can have a display device 302 for presenting a user interface displaying semantic travel modes according to example aspects of the present disclosure. Additionally, and/or alternatively, the user device 102 can include one or more sensor(s) 742 (e.g., associated with the user device 102, as described herein.

The user device 102 can also include a network interface 744 used to communicate with one or more other components of system 700 (e.g., a sound recording device, a biometric sensor, a vibration sensor) over the network 710. The network interface 744 can include any suitable components for interfacing with one more networks, including for example, transmitters, receivers, ports, controllers, antennas, or other suitable components.

The network 710 can be any type of communications network, such as a local area network (e.g. intranet), wide area network (e.g. Internet), cellular network, or some combination thereof. The network 710 can also include a direct connection between a user device 102 and the computing system 104. In general, communication between computing system 104 and a user device 102 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

Furthermore, computing tasks discussed herein as being performed at a server can instead be performed at a user device. Likewise, computing tasks discussed herein as being performed at the user device can instead be performed at the server.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of ascertaining semantic travel modes, the method comprising:
obtaining, by one or more computing devices, a plurality of location reports from a user device, wherein each of the plurality of location reports comprises at least a set of data indicative of an associated location and time;
determining, by the one or more computing devices, a travel period associated with the user device based on the plurality of location reports;
obtaining, by the one or more computing devices, one or more personalization signals that comprise a set of data associated with a semantic travel mode; and
determining, by the one or more computing devices, that the user device is associated with the semantic travel mode during the travel period based at least in part on the plurality of location reports and the one or more personalization signals.

2. The computer-implemented method of claim 1, wherein the one or more personalization signals are associated with at least one of an email indicative of the semantic travel mode, a web search query indicative of the semantic travel mode, a request indicative of the semantic travel mode, and a social media mention indicative of the semantic travel mode.

3. The computer-implemented method of claim 1, further comprising:
determining, by the one or more computing devices, a speed associated with the user device based at least in part on at least some of the plurality of location reports; and
determining, by the one or more computing devices, that the user device is associated with the semantic travel mode during the travel period based at least in part on the speed associated with the user device.

4. The computer-implemented method of claim 1, further comprising:
providing, by the one or more computing devices, a second set of data indicative of the semantic travel mode.

5. The computer-implemented method of claim 4, wherein providing the second set of data indicative of the semantic travel mode associated with the user device comprises:
providing for display, by the one or more computing devices, the semantic travel mode in a user interface presented on a display device associated with the user device.

6. The computer-implemented method of claim 5, further comprising:
obtaining, by the one or more computing devices from the user device, a confirmation that the user device is associated with the semantic travel mode during the travel period; and
determining, by the one or more computing devices, that the user device is associated with the semantic travel mode during the travel period based at least in part on the confirmation.

7. The computer-implemented method of claim 5, further comprising:
obtaining, by the one or more computing devices from the user device, an edit indicating that the user device is associated with a different semantic travel mode during the travel period; and
determining, by the one or more computing devices, that the user device is associated with the different semantic travel mode during the travel period based at least in part on the edit.

8. The computer-implemented method of claim 1, wherein determining, by the one or more computing devices, that the user device is associated with the semantic travel mode comprises:
determining, by the one or more computing devices, that the user device is associated with the semantic travel mode during the travel period based at least in part on a travel mode history.

9. The computer-implemented method of claim 8, wherein the travel mode history comprises one or more past semantic travel modes associated with a user of the user device.

10. The computer-implemented method of claim 8, wherein the travel mode history comprises one or more semantic travel modes associated with one or more other user devices that are different than the user device.

11. The computer-implemented method of claim 1, wherein the one or more personalization signals comprise a set of data associated with at least one of a sound recording device, a biometric sensor, and a vibration sensor.

12. A computing system, comprising:
one or more processors; and
one or more memory devices, the one or more memory devices storing computer-readable instructions that when executed by the one or more processors cause the one or more processors to perform operations, the operations comprising:
obtaining a plurality of location reports from a user device, wherein each of the plurality of location reports comprises at least a set of data indicative of an associated location and time;
determining a segment of a travel period associated with the user device based, at least in part, on the plurality of location reports;
obtaining one or more personalization signals that comprise a set of data associated with a semantic travel mode; and
determining that the user device is associated with the semantic travel mode during the segment of the travel period based at least in part on the plurality of location reports and the one or more personalization signals.

13. The computing system of claim 12, wherein the operations further comprise:
storing the semantic travel mode as part of a travel mode history for the user device.

14. The computing system of claim 12, wherein the one or more personalization signals comprise a first personalization signal and a second personalization signal, and where the operations further comprise:
assigning a first weight to the first personalization signal to create a first weighted personalization signal and a second weight to the second personalization signal to create a second weighted personalization signal; and
determining the semantic travel mode associated with the user device based at least in part on the weighted first personalization signal and the weighted second personalization signal.

15. The computing system of claim 12, wherein the operations further comprise:
obtaining one or more geographic signals associated with one or more geographic locations; and
determining the semantic travel mode associated with the user device based at least in part on the one or more geographic signals.

16. A computing system, comprising:
one or more processors; and
one or more memory devices, the one or more memory devices storing computer-readable instructions that when executed by the one or more processors cause the one or more processors to perform operations, the operations comprising:
obtaining a plurality of location reports from a user device, wherein each of the plurality of location reports comprises at least a set of data indicative of an associated location and time;
determining one or more segments of a travel period associated with the user device based, at least in part, on the plurality of location reports;
obtaining one or more personalization signals that comprises a set of data associated with one or more semantic travel modes; and
determining, for each of the one or more segments of the period of travel, that the user device is associated with at least one of the semantic travel modes during the respective segment based at least in part on the plurality of location reports and the one or more personalization signals.

17. The system of claim 16, wherein the one or more segments comprise a first segment associated with a first travel mode and a second segment associated with a second travel mode.

18. The system of claim 17, wherein the first semantic travel mode is different than the second semantic travel mode.

19. The computing system of claim 17, wherein the operations further comprise:
providing for display, in a user interface presented on a display device associated with the user device, the first travel mode and the second travel mode.

20. The computing system of claim 19, wherein the first and second semantic travel modes are provided such that a user of the user device can confirm at least one of that the user device is associated with the first semantic travel mode during the first segment and that the user device is associated with the second semantic travel mode during the second segment.
